(19) United States
(12) Patent Application Publication
(10) Pub. No.: US 2009/0291838 A1
(43) Pub. Date: Nov. 26, 2009

(54) Urea SCR catalyst and manufacturing method for the same

(75) Inventor: Gwon Koo Yeo, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/286,778

(22) Filed: Oct. 1, 2008

(30) Foreign Application Priority Data
May 22, 2008 (KR) 10-20087-0047455

(51) Int. Cl. B01J 29/064; B05D 5/00; B05D 1/36; B05D 3/02

(52) U.S. Cl. 502/74; 427/287; 427/419.3; 427/397.7

(57) ABSTRACT

The present invention features a selective reduction catalyst, where half of the catalyst (an inlet) is coated with Mn/TiO₂ and another half of the catalyst (an outlet) is coated with Fe-zeolite/ZSM along a substantially longitudinal direction and a washcoat layer is prepared by adding cerium carbonate, thereby forming pores caused by decomposition during calcinations in the washcoat layer and increasing active surface area and performance and efficiency of the catalyst. Also featured are methods of preparation of the selective reduction catalyst.

### CROSS-REFERENCE TO RELATED APPLICATION

This application claims under 35 U.S.C. §119(a) the benefit of Korean Patent Application No. 10-20087-0047455 filed May 22, 2008, the entire contents of which are incorporated herein by reference.

### BACKGROUND

(a) Technical Field

The present invention relates to a catalyst for selective catalytic reduction preparation methods, and, more particularly to a catalyst for selective catalytic reduction, where Mn—TiO₂ and Fe-zeolite are coated with a catalytic agent, thereby improving the activity of urea in removing nitrogen oxides both at low and high temperature, and to its preparation method.

(b) Background Art

The selective catalytic reduction (SCR) method has been described in the reduction of NOx discharge. In the SCR method, a catalyst, where V₂O₅ is coated onto TiO₂, is used in combination with ammonia (NH₃) as a reducing agent. It has been reported that reduction yield can be up to 80% when the reaction is performed at 300-400° C. and the oxygen concentration is higher than 2%.

However, in the conventional methods there is secondary pollution due to unreacted NH₃, and there are safety concerns related to the NH₃ tank and the necessity of a large-sized facility for reducing NOx because of the relatively low space velocity (5,000-10,000 hr⁻¹) of the V₂O₅/TiO₂ catalyst.

Accordingly, hydrocarbons have been used as a reducing agent in various combinations of catalysts where copper (Cu) is supported onto zeolite and can achieve 50% yield of reducing NOx.

However, although V₂O₅ catalytic agent has excellent activity at low temperature, it has poor durability at high temperature, and also produces secondary toxic materials. Catalytic agents that use zeolite have low activity at low temperature, but have high safety and performance at high temperature. Recent attempts to use Mn and Ce among metal oxides have not been successful.

The above information disclosed in this Background section is only for enhancement of understanding of the background of the invention and therefore it may contain information that does not form the prior art that is already known in this country to a person of ordinary skill in the art.

### SUMMARY

In one aspect, the present invention is directed to a selective reduction catalyst, where half of the catalyst (an inlet) is coated with Mn/TiO₂ and another half of the catalyst (an outlet) is coated with Fe-zeolite/ZSM along the longitudinal direction and a washcoat layer is prepared by adding cerium carbonate, thereby forming pores caused by decomposition during calcinations in the washcoat layer and increasing active surface area and performance and efficiency of the catalyst. The invention also features methods of preparation of the selective reduction catalyst as described in the aforementioned aspect.

In one embodiment, the present invention provides a selective reduction catalyst, where an inlet of the catalyst is coated with Mn/TiO₂ and an outlet of the catalyst is coated with Fe-zeolite/ZSM and each half of the catalyst is coated with the Mn/TiO₂ and the Fe-zeolite/ZSM along the longitudinal direction.

In another aspect, the invention provides a process of preparing a selective reduction catalyst comprising the steps of:
(a) preparing a first catalyst slurry comprising Mn/TiO2;
(b) preparing a second catalyst slurry comprising Fe-zeolite/ZSM;
(c) coating a ceramic monolithic support by immersing half of the ceramic monolithic support in the first catalyst slurry along the longitudinal direction;
(d) coating the ceramic monolithic support by immersing the other half of the ceramic monolithic support in the second catalyst slurry; and
(e) drying and calcinating the coated catalyst at an appropriate temperature for a predetermined time.

In one preferred embodiment, a washcoat layer is prepared by adding cerium carbonate before the coating steps, thereby forming pores caused by decomposition during calcinations in the washcoat layer.

In other embodiments, according to a selective reduction catalyst and its preparation method of the present invention as described herein, a washcoat prepared by using cerium carbonate before coating steps in catalyst structure, where both Mn/TiO₂ and Fe-zeolite/ZSM are applied, produces pores caused by the decomposition during calcination in the washcoat, thereby increasing active surface area and improving the performance and efficiency of the catalyst.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 schematically shows large-sized diesel SCR post-treatment system according an embodiment of the present invention.

FIG. 2 is photographs showing the increase in active surface area of porous SCR catalyst according to the present invention.

Reference numerals set forth in the Drawings includes reference to the following elements as further discussed below.
10: Selective reduction catalyst
11: Mn/TiO₂
12: Fe-zeolite/ZSM

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes a selective reduction catalyst using urea, comprising (a) an inlet of the catalyst is coated with Mn/TiO2 and (b) an outlet of the catalyst is coated with Fe-zeolite/ZSM. In certain embodiments, each half of the catalyst is coated with the Mn/TiO2 and the Fe-zeolite/ZSM along a substantially longitudinal direction.

The present invention also includes a process of preparing a selective reduction catalyst, comprising the steps of preparing a first catalyst slurry comprising Mn/TiO2, preparing a second catalyst slurry comprising Fe-zeolite/ZSM, coating a ceramic monolithic support with the first catalyst slurry along the longitudinal direction, and coating the ceramic monolithic support with the second catalyst slurry. Preferably the coated catalyst is dried.

In preferred embodiments of the process, drying the coated catalyst further comprises drying and calcinating the coated catalyst at an appropriate temperature for a predetermined time.

In further embodiments, the step of coating a ceramic monolithic support with a first catalyst slurry further comprises immersing half of the ceramic monolithic support in the first catalyst slurry along the longitudinal direction. In still further embodiments, the step of coating a ceramic monolithic support with a second catalyst slurry further comprises immersing the other half of the ceramic monolithic support in the second catalyst slurry.

In other embodiments, a washcoat layer is prepared by adding cerium carbonate.

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

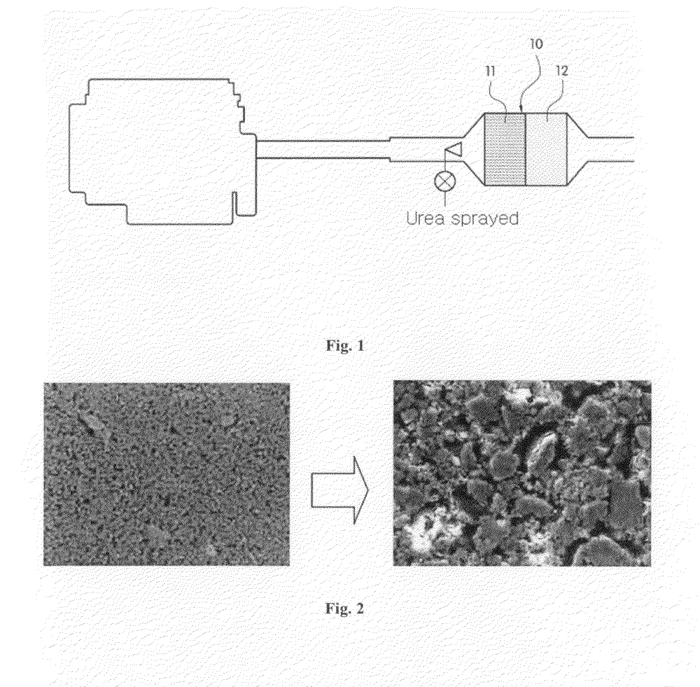

FIG. 1 schematically shows large-sized diesel SCR post-treatment system according an exemplary embodiment of the present invention. FIG. 2 are photographs showing the increase in active surface area of porous SCR catalyst according to the present invention.

According to preferred embodiments of the present invention, an inlet of catalyst is suitably coated with Mn/TiO₂(11) catalyst superior in low-temperature activity, and an outlet of catalyst is suitably coated with Fe-zeolite/ZSM-5(12) superior in high-temperature activity, thereby improving the catalytic activity of urea in removing nitrogen oxides both at low and high temperature.

In certain preferred embodiments, the present invention is directed to a SCR catalyst where each half of the structure is preferably coated with Mn/TiO₂(11) and Fe-zeolite, respectively, and a washcoat is preferably prepared by using cerium carbonate (CeCO₃) to form pores caused by decomposition during calcinations, thereby suitably increasing active surface area and improving performance and efficiency of catalyst.

Catalyst slurries can be readily prepared. For instance, to prepare a first slurry, Mn/TiO_{2 c} can be admixed with alumina, or another suitable carrier, in a wide variety of mixing ratios. Preferably, a water slurry is prepared and the slurry is acidified (e.g., to a pH of about 5 or greater, to a pH pf about 4.5 or greater, to a pH of about 4 or greater) by the addition of an inorganic acid, for example acetic acid.

To prepare a second slurry beta zeolite can be admixed with ZSM-5, or another suitable carrier, in a mixing ratio, where preferably, the ratio of zeolite can be varied depending on the desired performance in hydrocarbon decomposition. Preferably, a water slurry is prepared and the slurry is acidified (e.g., to a pH of about 5 or greater, to a pH pf about 4.5 or greater, to a pH of about 4 or greater) by the addition of an inorganic acid, for example acetic acid.

### EXAMPLES

The following examples illustrate the present invention and are not intended to limit the same.

### Example

In one example, to prepare a first catalyst slurry, Mn/TiO₂(11) superior in low-temperature activity is mixed with alumina, for example in a mixing ratio of 1:10-2:8 (50 g), and added with a mixture of 5 g of cerium carbonate (CeCO₃), 27.0 g of acetic acid and 375 mL of water, followed by the adjustment of pH to 4.2 by using acetic acid.

Catalyst slurry (viscosity 200-300 cpsi, solid content: 30-40%) was obtained according to a ball mill method by milling the slurry in such a manner that particles with size of less than 7 μm may amount to 94%. The aforementioned ranges are preferred considering durability, thermal resistance and initial performance of catalyst.

To prepare a second catalyst slurry, beta zeolite and ZSM-5 are suitably mixed in a mixing ratio of 1:1 (50 g), and added with a mixture of 5 g of cerium carbonate (CeCO₃), 27.0 g of acetic acid and 375 mL of water, followed by the adjustment of pH to 4.2 by using acetic acid.

Preferably, the ratio of zeolite can be varied depending on the desired performance in hydrocarbon decomposition. Catalyst slurry (viscosity 200-300 cpsi, solid content: 30-40%) was suitably obtained according to a ball mill method by milling the slurry in such a manner that particles with size of less than 7 μm may preferably amount to 94%. The aforementioned ranges are preferred considering durability, thermal resistance and initial performance of catalyst.

In preferred examples, a ceramic monolithic support (i.e. 1 L 400 cell ceramic support) is suitably coated with the selective reduction catalyst by immersing half of the selective reduction catalyst (the side of inlet) in the first catalyst slurry. Another half of the selective reduction catalyst was also immersed in the length direction in the second catalyst slurry.

According to further preferred embodiments, the catalyst is dried in a furnace (150° C.) for 2 hours, and calcinated in an electric furnace (450-550° C.) for 4 hours.

In a preferred SCR catalyst, each half structure of which is coated with Mn/TiO₂(11) and Fe-zeolite/ZSM-5 (12), respectively, a washcoat was suitably prepared by using cerium carbonate (CeCO₃) before the coating steps to form pores caused by decomposition during the calcination, thereby suitably increasing the active surface area of catalyst as shown in FIG. 2 and improving the efficiency and performance of catalyst.

### Comparative Example

ZSM-5 (50 g) was placed in a solution of acetic acid (27.0 g) and water (375 mL), and pH was adjusted by using acetic acid to 4.2. Catalyst slurry (viscosity 200-300 cpsi, solid content: 30-40%) was obtained according to a ball mill method by milling the slurry in such a manner that particles with size of less than 7 μm may amount to 94%. Selective reduction (scr) catalyst was obtained by coating the catalyst slurry for the comparison.

### Test Example

Selective reduction catalysts(10) prepared in Example and Comparative Example were suitably aged (heat treated) in an electric furnace at 750° C. for 24 hours. Catalytic activities were compared, and the results are presented in Table 1. Table 1 shows the NOx reducing efficiency.

TABLE 1
NOx reducing efficiency

| | Comparative | Example (the |
|---|---|---|
| Category | Example | present invention) |
| Catalytic activity | 91 | 95 |
| (non-aged) | | |
| Catalytic activity (aged) | 64 | 76 |

(*hydrothermally aged at 750° C. for 24 hours)

Catalytic activities shown in Table 1 are activities of removing the material, and higher value reflects suitably better activity. Table 1 shows that the catalyst prepared in the Example has better NOx reducing power using urea than the catalyst shown in the Comparative Example.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A selective reduction catalyst using urea, wherein an inlet of the catalyst is coated with Mn/TiO₂ and an outlet of the catalyst is coated with Fe-zeolite/ZSM, and each half of the catalyst is coated with the Mn/TiO₂ and the Fe-zeolite/ZSM along the longitudinal direction.

2. A process of preparing a selective reduction catalyst, comprising the steps of:
(a) preparing a first catalyst slurry comprising Mn/TiO₂;
(b) preparing a second catalyst slurry comprising Fe-zeolite/ZSM;
(c) coating a ceramic monolithic support by immersing half of the ceramic monolithic support in the first catalyst slurry along the longitudinal direction;
(d) coating the ceramic monolithic support by immersing the other half of the ceramic monolithic support in the second catalyst slurry; and.
(e) drying and calcinating the coated catalyst at an appropriate temperature for a predetermined time.

3. The process of claim 2, wherein a washcoat layer is prepared by adding cerium carbonate.

4. A selective reduction catalyst using urea, wherein an inlet of the catalyst is coated with Mn/TiO₂ and an outlet of the catalyst is coated with Fe-zeolite/ZSM.

5. The selective reduction catalyst of claim 4, wherein each half of the catalyst is coated with the Mn/TiO₂ and the Fe-zeolite/ZSM along the longitudinal direction.

6. A process of preparing a selective reduction catalyst, comprising the steps of:
(f) preparing a first catalyst slurry comprising Mn/TiO₂;
(g) preparing a second catalyst slurry comprising Fe-zeolite/ZSM;
(h) coating a ceramic monolithic support with the first catalyst slurry along the longitudinal direction; and
(i) coating the ceramic monolithic support with the second catalyst slurry.

7. The method of claim 6, further comprising drying the coated catalyst.

8. The process of preparing a selective reduction catalyst of claim 6, wherein drying the coated catalyst further comprises drying and calcinating the coated catalyst at an appropriate temperature for a predetermined time.

9. The process of preparing a selective reduction catalyst of claim 6, wherein the step of coating a ceramic monolithic support with a first catalyst slurry further comprises immersing half of the ceramic monolithic support in the first catalyst slurry along the longitudinal direction.

10. The process of preparing a selective reduction catalyst of claim 9, wherein the step of coating a ceramic monolithic support with a second catalyst slurry further comprises immersing the other half of the ceramic monolithic support in the second catalyst slurry.

11. The process of claim 6, wherein a washcoat layer is prepare by adding cerium carbonate.
